(19) United States
(12) Patent Application Publication
(10) Pub. No.: US 2017/0168607 A1
(43) Pub. Date: Jun. 15, 2017

(54) IN-CELL TOUCH SCREEN, DISPLAY DEVICE AND METHOD FOR MANUFACTURING THE SAME

(71) Applicants: BOE Technology Group Co., Ltd., Beijing (CN); Hefei Xinsheng Optoelectronics Technology Co., Ltd, Anhui (CN)

(72) Inventors: Binbin Cao, Beijing (CN); Yinhu Huang, Beijing (CN)

(21) Appl. No.: 15/327,546

(22) PCT Filed: Mar. 28, 2016
(86) PCT No.: PCT/CN2016/077551

§ 371 Date: Jan. 19, 2017

(30) Foreign Application Priority Data
May 18, 2015 (CN) 201510254203.8

(51) Int. Cl. G06F 3/044; G09G 3/36

(52) U.S. Cl. CPC G06F 3/044; G09G 3/3648; G09G 2300/0426

(57) ABSTRACT

Disclosed is an in-cell touch screen, a display device and a method for manufacturing the same. The in-cell touch screen includes: an array substrate; a color filter substrate; and a plurality of spacers disposed between the array substrate and the color filter substrate, each spacer including a top surface, a first side surface and a second side surface opposite to the first surface. The in-cell touch screen further includes a touch electrode laid on the top surface and at least a part of the first side surface and/or the second side surface. In the present invention, the touch electrode is laid on the pillar spacers, thus it is possible to increase a surface area of the touch electrode so that the mutual capacitance between the touch driving electrode and the touch sensing electrode is increased so as to increase the inductive capacitance generated when there is a touch by a finger. Meanwhile, it is possible to reduce the influence of the liquid crystal layer on the touch effect and improve the signal-noise-ratio and further improve sensitivity and accuracy of touch identification.

### CROSS-REFERENCE TO RELATED APPLICATION

This application is a national phase application of PCT/CN2016/077551 field on Mar. 28, 2016, which published on Nov. 24, 2016 as WO 2016/184256 A1, and claims priority to Chinese Patent Application No. 201510254203.8 filed on May 18, 2015 in the State Intellectual Property Office of China, the whole disclosure of which is incorporated herein by reference.

### BACKGROUND OF THE INVENTION

Field of the Invention

Embodiments of the present invention relate to field of display technique, in particular to an in-cell touch screen, a display device and a method for manufacturing the same.

Description of the Related Art

With the development of display technique, a touch screen has been widely used by people. Currently, the touch screen may comprises an out-cell touch screen and an in-cell touch screen. A display module and a touch module of the out-cell touch screen are two individual components and combined with each other through a post adhesion process. In the in-cell touch screen, the touch module is embedded in the display module so that the two modules are integrated with each other, rather than being two individual components. In this way, it is possible to reduce a thickness of the whole assembly. Further, it is also possible to greatly reduce manufacturing cost of the touch screen. Thus, the in-cell touch screen is more and more popular for manufacturers.

The in-cell touch screen comprises a touch electrode consisting of a touch driving electrode and a touch sensing electrode. When a voltage is applied to the touch driving electrode and the touch sensing electrode, an electrical field is formed between the touch driving electrode and the touch sensing electrode so as to realize a touch sensing function.

At present, the in-cell touch screen is mainly a mutual capacitance type. The touch electrode is disposed on an array substrate. FIG. 1 shows a structure of an in-cell touch screen comprising an array substrate 22, a passivation layer 26, touch electrodes 24, a liquid crystal layer 27, spacers 23, an optical compensation layer 25, a color filter 21 sequentially laminated, wherein all the touch electrodes 24 are located on a side of the array substrate 22 and are formed by dividing a common electrode and ITO (Indium Tin Oxides). The spacer 23 in a pillar form is located on a side of the color filter 21 and disposed on an upper surface of the touch electrode 24 to control a thickness of the cell. The liquid crystal layer 27 needs to be penetrated when there is a touch by a finger, which may result in a small inductive capacitance, a low signal-noise ratio, thereby resulting in a low sensitivity and accuracy in touch identification.

### SUMMARY OF THE INVENTION

Embodiments of the present invention are intended to provide an in-cell touch screen, a display device and a method for manufacturing the same to address at least above mentioned problem.

According to a first aspect of the present invention, there is provided an in-cell touch screen comprising: an array substrate; a color filter substrate; and a plurality of spacers disposed between the array substrate and the color filter substrate, each spacer including a top surface, a first side surface and a second side surface opposite to the first side surface, wherein the in-cell touch screen further comprises a touch electrode laid on the top surface and at least a part of the first side surface and/or the second side surface.

According to an exemplary embodiment of the present invention, the touch electrode comprises a touch driving electrode and a touch sensing electrode; the touch driving electrode is laid on the top surface and the first side surface; and the touch sensing electrode is laid on the top surface and the second side surface.

According to an exemplary embodiment of the present invention, the in-cell touch screen further comprises a passivation layer disposed on the array substrate, on which the pillar spacers are disposed.

According to an exemplary embodiment of the present invention, the touch driving electrode is laid on a first region of the passivation layer contiguous with the first side surface.

According to an exemplary embodiment of the present invention, the touch sensing electrode is laid on a second region of the passivation layer contiguous with the second side surface.

According to an exemplary embodiment of the present invention, the touch driving electrode and the touch sensing electrode are laid on the top surface to be spaced apart from each other.

According to an exemplary embodiment of the present invention, the top surface, the first side surface and the second side surface each are entirely laid with the touch electrode.

According to an exemplary embodiment of the present invention, the top surface, the first side surface and the second side surface each are partially laid with the touch electrode.

According to a second aspect of the present invention, there is provided a display device comprising the in-cell touch screen as described in the first aspect.

According to a third aspect of the present invention, there is provided a method for manufacturing an in-cell touch screen comprising steps of: after forming a passivation layer (PVX) on a side of a substrate, forming a plurality of spacers on the passivation layer; and laying a touch electrode on a top surface, a first side surface and a second side surface of the spacers after forming the spacers, wherein the first side surface is opposite to the second side surface.

According to an exemplary embodiment of the present invention, laying a touch electrode on a top surface, a first side surface and a second side surface of the spacers comprises: laying a touch driving electrode on the first side surface; laying a touch sensing electrode on the second side surface; and laying the touch driving electrode and the touch sensing electrode on the top surface.

According to an exemplary embodiment of the present invention, the method further comprises: laying the touch driving electrode on a first region of the passivation layer contiguous with the first side surface.

According to an exemplary embodiment of the present invention, the method further comprises laying the touch sensing electrode on a second region of the passivation layer contiguous with the second side surface.

According to an exemplary embodiment of the present invention, laying the touch driving electrode and the touch sensing electrode on the top surface comprises laying the touch driving electrode and the touch sensing electrode on the top surface such that the touch driving electrode and the touch sensing electrode are spaced apart from each other.

With the touch screen according to the embodiments of the present application, the touch electrode is laid on the spacers, thus it is possible increase a surface area of the touch electrode so that the mutual capacitance between the touch driving electrode and the touch sensing electrode is increased so as to increase the inductive capacitance generated when there is a touch by a finger. Meanwhile, it is possible to reduce influence of the liquid crystal layer to the touch sensing and improve the signal-noise-ratio and improve sensitivity and accuracy of touch identification.

### BRIEF DESCRIPTION OF THE DRAWINGS

In order to clearly describe schemes of embodiments of the present invention, accompanying drawings necessary for describing the embodiments of the present invention will be simply described. Obviously, the accompanying drawings described below are merely some embodiments of the present invention, and those ordinary skilled in the art may arrive at other accompanying drawings based on these accompanying drawings without any inventive steps.

FIG. 1 is a schematic structural view of an in-cell touch screen in the prior art;

FIG. 2 is a schematic structural view of an in-cell touch screen according to an exemplary embodiment of the present invention;

FIG. 3 is a schematic view of a pillar spacer in FIG. 2;

FIG. 4 is a schematic view of a top surface of the a pillar spacer according to an exemplary embodiment of the present invention;

FIG. 5 is a schematic section view of a first pillar spacer taken along A-A line in FIG. 4;

FIG. 6 is a schematic section view of a second pillar spacer taken along B-B line in FIG. 4; and

FIG. 7 is a flow chart of a method for manufacturing an in-cell touch screen according to an exemplary embodiment of the present invention.

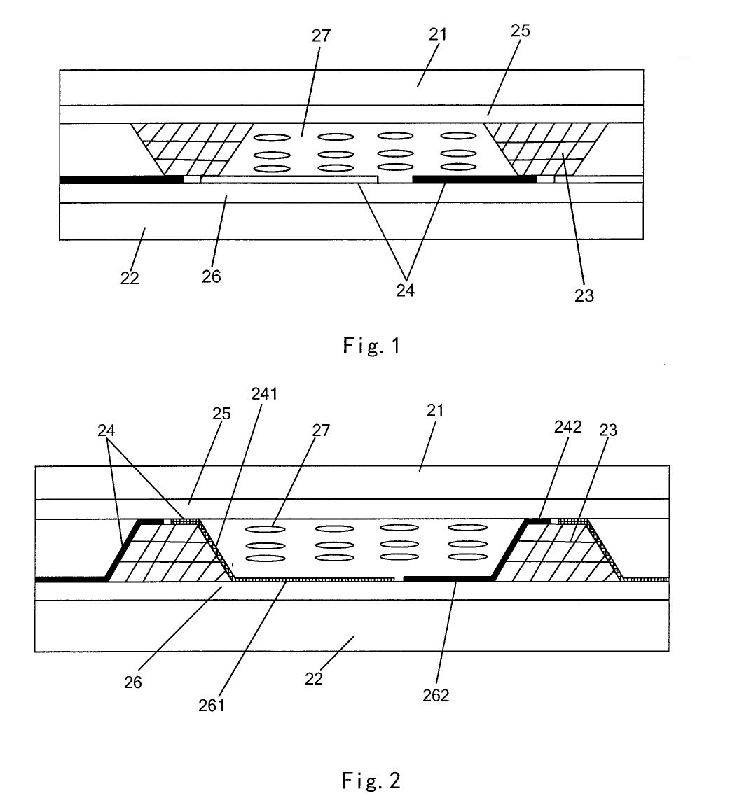

### DETAILED DESCRIPTION OF PREFERRED EMBODIMENTS OF THE INVENTION

In order to make the objects, schemes and advantages more clear, embodiments of the present invention will be described in detail with reference to the accompanying drawings.

FIG. 2 is a schematic structural view of an in-cell touch screen according to an exemplary embodiment of the present invention. Referring to FIG. 2, the in-cell touch screen comprises a color filter substrate (CF) substrate 21, an array substrate 22, a plurality of pillar spacers 23, a touch electrode 24, an optical compensation (OC) layer 25, a passivation layer (PVX) 26 and a liquid crystal layer 27. The touch electrode 24 includes a touch driving electrode 241 and a touch sensing electrode 242.

The pillar spacers 23 are formed on a side of the array substrate 22. Referring to FIG. 2, the pillar spacers 23 are disposed on the PVX 26 on the side the array substrate 22. That is, when manufacturing the in-cell touch screen, the pillar spacers 23 are formed on the PVX 26 after forming the PVX 26. In an exemplary embodiment of the present invention, the pillar spacers 23 are provided between the CF substrate 21 and the array substrate 22 for the following reasons: since the volume of liquid crystal molecules varies to contract or expand due to temperature change, and a liquid crystal panel has an enclosed vacuum structure, the liquid crystal panel may generate vacuum bubbles at a low temperature or occur a gravity defect at a high temperature, so that the liquid crystal layer has an uneven thickness. However, when the pillar spacers 23 are disposed between the CF substrate 21 and the array substrate 22, the pillar spacers 23 can support the CF substrate 21 and the array substrate 22 and maintain a space therebetween, thereby avoiding the CF substrate 21 and the array substrate 22 from being dislocated with each other or avoiding a gap of the liquid crystal panel from not being restored in time which may result in defects such as light leaking, poor picture quality or the like, when an external force is exerted on the liquid crystal panel with the enclosed structure.

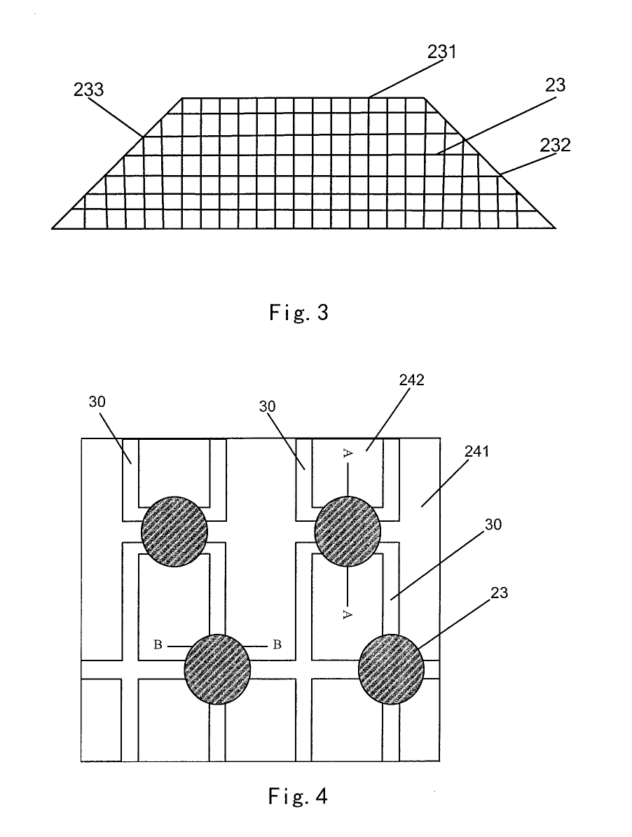

Referring to FIG. 3, the illustrated pillar spacer 23 each comprises a top surface 231, a first side surface 232 and a second side surface 233. The touch electrode 24 is laid on the top surface 231, the first side surface 232 and the second side surface 233 of each pillar spacer 23, and the first side surface 232 is opposite to the second side surface 233. The first side surface 232 and the second side surface 233 are side surfaces proximate to the liquid crystal layer 27. Further, the touch driving electrode 241 is laid on the top surface 231 and the first side surface 232. The touch sensing electrode 242 is laid on the top surface 231 and the second side surface 233.

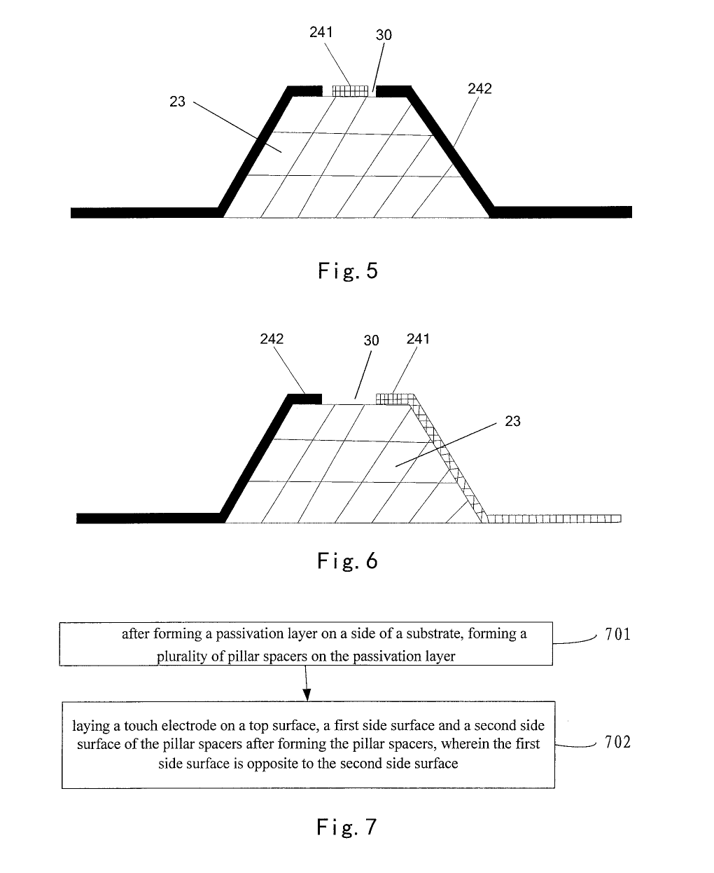

Referring to FIG. 4, the touch driving electrode 241 and the touch sensing electrode 242 are laid on the top surface 231 to be spaced apart from each other. A circular region in FIG. 4 corresponds to a pillar spacer. In FIG. 4, a slit portion 30 is formed between the touch driving electrode 241 and the touch sensing electrode 242. For clearly showing a laying effect of the touch electrode 24 on the top surface 231, the first side surface 232 and the second side surface 233, FIG. 5 illustrates a schematic section view corresponding to A-A part in FIG. 4, and FIG. 6 illustrates a schematic section view corresponding to B-B part in FIG. 4. As shown in FIGS. 5 and 6, the laying effect of the touch electrode 24 is different from different viewing point. In FIG. 5, the top surface of one pillar spacer is laid with the touch driving electrode and the touch sensing electrode, and both the two side surfaces thereof are laid with the touch sensing electrode. In FIG. 6, the top surface of one pillar spacer is laid with the touch driving electrode and the touch sensing electrode, and one of the two side surfaces thereof is laid with the touch sensing electrode, and the other is laid with the touch driving electrode.

A touch principle will be described below in detail. When a touch driving signal is applied to the touch driving electrode 241, an inductive voltage signal of the touch sensing electrode 242 generated through mutual capacitance coupling is detected. During this process, if a human body touches the in-cell screen, an electrical field of the human body will be exerted on the mutual capacitance so that a capacitance value thereof varies to change the inductive voltage signal of the touch sensing electrode 242 coupled through the mutual capacitance, thereby a touching position can be determined according to the change of the inductive voltage signal. Since the touch driving electrode 241 and the touch sensing electrode 242 are disposed above the pillar spacers 23 according to the embodiments of the present application, the mutual capacitance will be increased. Further, an inductive capacitance will also be increased during touching by a finger, and an effect of the liquid crystal layer on the touching will be decreased.

In an exemplary embodiment of the present invention, each pillar spacer 23 may be completely covered with the touch electrode 24. That is, the top surface 231, the first side surface 232 and the second side surface 233 of the pillar spacer 23 expect the slit portions 30 each are entirely laid with the touch electrode 24. Alternatively, each pillar spacer 23 may be partially covered with the touch electrode 24. That is, the top surface 231, the first side surface 232 and the second side surface 233 of the pillar spacer 23 each are partially laid with the touch electrode 24. For example, 50% region on the top surface 231, 50% region on the first side surface 232, and 50% region on the second side surface are laid with the touch electrode 24. However, embodiments of the present invention are not limited herein. The top surface 231, the first side surface 232 and the second side surface 233 of each pillar spacer 23 may be laid with the touch electrode 24 as desired

Moreover, in addition to the pillar spacers 23 being laid with the touch electrode 24 thereon, the PVX 26 is also laid with the touch electrode 24 thereon. In FIG. 2, a first region 261 contiguous with the first side surface 231 is laid with the touch driving electrode 241, and a second region 262 contiguous with the second side surface 232 is laid with the touch sensing electrode 242. Both the first region 261 and the second region 262 are regions on the PVX.

With the in-cell touch screen according to embodiments of the present invention, the touch electrode is laid on the pillar spacer, thus it is possible to increase a surface area of the touch electrode so that the mutual capacitance between the touch driving electrode and the touch sensing electrode is increased so as to increase the inductive capacitance generated when there is a touch by a finger. Meanwhile, it is possible to reduce the influence of the liquid crystal layer on the touch effect and improve the signal-noise-ratio and further improve sensitivity and accuracy of touch identification.

According to another aspect, there is provided a display device comprising the in-cell touch screen as described in any one of the above embodiments.

With the display device according to embodiments of the present invention, the touch electrode is laid on the pillar spacer, thus it is possible to increase a surface area of the touch electrode so that the mutual capacitance between the touch driving electrode and the touch sensing electrode is increased so as to increase the inductive capacitance generated when there is a touch by a finger. Meanwhile, it is possible to reduce the influence of the liquid crystal layer on the touch effect and improve the signal-noise-ratio and further improve sensitivity and accuracy of touch identification.

FIG. 7 is a flow chart of a method for manufacturing an in-cell touch screen according to an exemplary embodiment of the present invention. Referring to FIG. 7, the flow chart of the method comprises steps of:

701: after forming a passivation layer (PVX) on a side of a substrate, forming a plurality of pillar spacers on the passivation layer;

702: laying a touch electrode on a top surface, a first side surface and a second side surface of the pillar spacers after forming the pillar spacers, wherein the first side surface is opposite to the second side surface.

Specifically, laying a touch electrode on a top surface, a first side surface and a second side surface of each pillar spacer may particularly comprises:

laying a touch driving electrode on the first side surface; laying a touch sensing electrode on the second side surface; and laying the touch driving electrode and the touch sensing electrode on the top surface. Optionally, the method further comprises: laying the touch driving electrode on a first region of the PVX contiguous with the first side surface.

Optionally, the method further comprises: laying the touch sensing electrode on a second region of the PVX contiguous with the second side surface.

Laying the touch driving electrode and the touch sensing electrode on the top surface may comprises:

laying the touch driving electrode and the touch sensing electrode on the top surface such that the touch driving electrode and the touch sensing electrode are spaced apart from each other.

Note that, the touch electrode can be laid in the above manner regardless of the number of the pillar spacers 23 between the CF substrate and the array substrate.

With the method according to embodiments of the present invention, after forming the pillar spacers, the touch electrode is laid on the pillar spacers, thus it is possible to increase a surface area of the touch electrode so that the mutual capacitance between the touch driving electrode and the touch sensing electrode is increased so as to increase the inductive capacitance generated when there is a touch by a finger. Meanwhile, it is possible to reduce the influence of the liquid crystal layer on the touch effect and improve the signal-noise-ratio and further improve sensitivity and accuracy of touch identification.

Those skilled in the art should understand that all or a part of the steps realizing the above embodiments may be performed through a hardware, or performed by relevant hardware under instruction by a program stored in a computer readable storage medium. The computer readable storage medium may include a ROM, a magnetic disc or an optical disc.

The above embodiments are only preferred embodiments of the present invention and not intended to limit the present invention. Various changes or modifications made without departing from the spirit and scope of the present invention should fall within the scope of the present invention.

1. An in-cell touch screen comprising:
an array substrate;
a color filter substrate; and
a plurality of spacers disposed between the array substrate and the color filter substrate, each spacer including a top surface, a first side surface and a second side surface opposite to the first side surface,
wherein the in-cell touch screen further comprises a touch electrode laid on the top surface and at least a part of the first side surface and/or the second side surface of the pillar spacers.

2. The in-cell touch screen according to claim 1, wherein
the touch electrode comprises a touch driving electrode and a touch sensing electrode;
the touch driving electrode is laid on the top surface and the first side surface; and
the touch sensing electrode is laid on the top surface and the second side surface.

3. The in-cell touch screen according to claim 2, further comprising a passivation layer which is disposed on the array substrate and on which the pillar spacers are disposed.

4. The in-cell touch screen according to claim 3, wherein the touch driving electrode is laid on a first region of the passivation layer contiguous with the first side surface.

5. The in-cell touch screen according to claim 3, wherein the touch sensing electrode is laid on a second region of the passivation layer contiguous with the second side surface.

6. The in-cell touch screen according to claim 2, wherein the touch driving electrode and the touch sensing electrode are laid on the top surface to be spaced apart from each other.

7. The in-cell touch screen according to claim 2, wherein the top surface, the first side surface and the second side surface each are entirely laid with the touch electrode.

8. The in-cell touch screen according to claim 2, wherein the top surface, the first side surface and the second side surface each are partially laid with the touch electrode.

9. A display device comprising the in-cell touch screen according to claim 1.

10. A method for manufacturing an in-cell touch screen, comprising:
after forming a passivation layer on a side of a substrate, forming a plurality of spacers on the passivation layer; and
laying a touch electrode on a top surface, a first side surface and a second side surface of the spacers after forming the spacers, the first side surface being opposite to the second side surface.

11. The method according to claim 10, wherein laying a touch electrode on a top surface, a first side surface and a second side surface of the spacers comprises:
laying a touch driving electrode on the first side surface;
laying a touch sensing electrode on the second side surface; and
laying the touch driving electrode and the touch sensing electrode on the top surface.

12. The method according to claim 11, further comprising:
laying the touch driving electrode on a first region of the passivation layer contiguous with the first side surface.

13. The method according to claim 11, further comprising:
laying the touch sensing electrode on a second region of the passivation layer contiguous with the second side surface.

14. The method according to claim 11, wherein laying the touch driving electrode and the touch sensing electrode on the top surface comprises:
laying the touch driving electrode and the touch sensing electrode on the top surface such that the touch driving electrode and the touch sensing electrode are spaced apart from each other.

15. The display device according to claim 9, wherein
the touch electrode comprises a touch driving electrode and a touch sensing electrode;
the touch driving electrode is laid on the top surface and the first side surface; and
the touch sensing electrode is laid on the top surface and the second side surface.

16. The display device according to claim 15, the in-cell touch screen further comprises a passivation layer which is disposed on the array substrate and on which the pillar spacers are disposed.

17. The display device according to claim 16, wherein the touch driving electrode is laid on a first region of the passivation layer contiguous with the first side surface.

18. The display device according to claim 16, wherein the touch sensing electrode is laid on a second region of the passivation layer contiguous with the second side surface.

19. The display device according to claim 15, wherein the touch driving electrode and the touch sensing electrode are laid on the top surface to be spaced apart from each other.

20. The display device according to claim 15, wherein the top surface, the first side surface and the second side surface each are entirely or partially laid with the touch electrode.
